(19) United States
(12) Patent Application Publication
(10) Pub. No.: US 2023/0315046 A1
(43) Pub. Date: Oct. 5, 2023

(54) Tile-Building Material Replication and Reproduction

(71) Applicant: Candice Folmar, Lake Elsinore, CA (US)

(72) Inventor: Candice Folmar, Lake Elsinore, CA (US)

(21) Appl. No.: 17/709,168

(22) Filed: Mar. 30, 2022

(51) Int. Cl. G05B 19/4099

(52) U.S. Cl. CPC G05B 19/4099; G05B 2219/49007

(57) ABSTRACT

This invention relates to a method for a ceramic 3D printing and shaping comprising the steps of building a two or three dimensional computerized model of target part, wherein the computerized model is a formatted file compatible with a three dimensional printer, 3D printing a replication of the target part, Creating mold from replication, firing the target part to harden; possibly multiple times, scanning an image of the design on the part in a computerized file and placing the image of the design onto the part.

This application claims the benefit of U.S. Provisional Application No. 63/168,724, filed Mar. 31, 2021

### BACKGROUND OF THE INVENTION

In many areas of technology, ceramic products are being used for their inert properties and heat resistance.

Many Rapid Prototyping processes have been developed in recent years and many more are currently being researched, but until recently, few of them have been used to fabricate ceramic objects.

One of the main challenges of the use of ceramic products with modern technologies to accurately replicated broken, damaged, or missing tiles that are no longer made. Some tiles that require replacement ₐ₁₋ₑ several decades or centuries old and to replicate the size and patterns on such tiles requires precise dimensional control.

One of the first patents pertaining io the background of the present invention was obtained by Bredt et al. and is entitled “Method of three dimensional printing” (U.S. Pat. No. 5,902,441), May 1 L 1999. This patent described the use of ink-jet print beads to deliver an aqueous solvent to a powder in cross-sections. This patent describes the basic technology of printers that may be used in accordance with the present invention, such as those commercially available from Z-corp of Burlington, Mass.Λ subsequent patent obtained by Bredt et al and entitled “Method of three dimensional printing” ((U.S. Pat. No. 7,087,109), Aug. 8, 2006 further describes the use of three-dimensional printer systelns. Subsequent patents by Jialin Shen (U.S. Published Pat. Appl. 20020016387: 2002; and Kenneth Newell (U.S. Published Pat Appl. 20040081573; 2004) describe means of producing more stable, stronger, and more durable RP objects through various combinations of binder and solvent. Newell's method produces a “green object,’, an unfired ceramic negative for use as a mold for injected metal. Improvements in Newell's mold-making methods are found in subsequent patents by Bardes, Bruce Paul et al (U.S. Published Pat. Appls. 20040151935, 20040152581 and 20050252631: 2004 and 2005) and Lynch, Robert F. et al. (U.S. Published Pat. App. 20050281701; 2005).

An article entitled “Rapid Prototyping with Ceramics” by Elizabeth A Judson & Thomas L. Starr of the Materials Science and Engineering of the Georgia Institute of Technology (found at http://www.pelcor.com/library/judson_starr/) explains the use of “Injection Molding and Stereolithography” for the creation of molds for casting purposes.

A publication entitled “The CAM-LEM Process” (found at http://dora.eeap.c,.vru.edu/carnlem/camproc.html) explains how layers of ceramic material can be cut with the use of a computer assisted laser cutter and then stacked and fused in order to obtain a final ceramic article.

Notwithstanding these developments, here remains a need for methods of making shaped ceramics in an efficient manner while replicating the dimensions and patters of the tiles.

### SUMMARY

The technical problem to be solved is, the shortcoming overcoming above prior art: technique is simple, equipment cost is low to provide one, the spacing of powder particle in ceramic size can be reduced in extrusion, consistency is high, and do not limited by ceramic particle kind and part shape, the method being suitable for preparing the ceramic 3D printing shaping of the ceramic of various ceramic material, various complicated shape.

The method involves 3D printing shapes of any size or dimension, comprising:

Creating a two dimensional or the three dimensional model of target part. The model should be in a computer formatted file compatible with any three dimensional printers being used to create the target part, preferably the model should be in a STL format.

Printing the target part, in either two or three dimensions, on a three-dimensional (“3D”) printer capable of printing the target part with the desired materials, including plastic, ceramic, polymers, co-polymers, paper, cement, and other materials that can be made with a 3D printer. The target part is preferably made with ceramics.

The type of printer selected will be based on the materials the target part is to be printed with.

The most preferred printer is a 3D printer that can be used to print ceramic items, preferably tiles.

The preferred 3D printers will use ceramic powders including one or more in oxide ceramics (such as aluminum oxide ceramics, zirconia ceramics, magnesia ceramics), carbide ceramics (such as reaction silicon carbide ceramics, without pressure silicon carbide ceramics, boron carbide ceramics, titanium carbide ceramic, zirconium carbide ceramics), nitride ceramics (silicon nitride ceramics, boron nitride ceramics, aluminum nitride ceramics, titanium nitride ceramic), bioceramic, glass ceramics.

### BRIEF DESCRIPTION

Referring now to the drawings in which like reference numbers represent corresponding parts throughout:

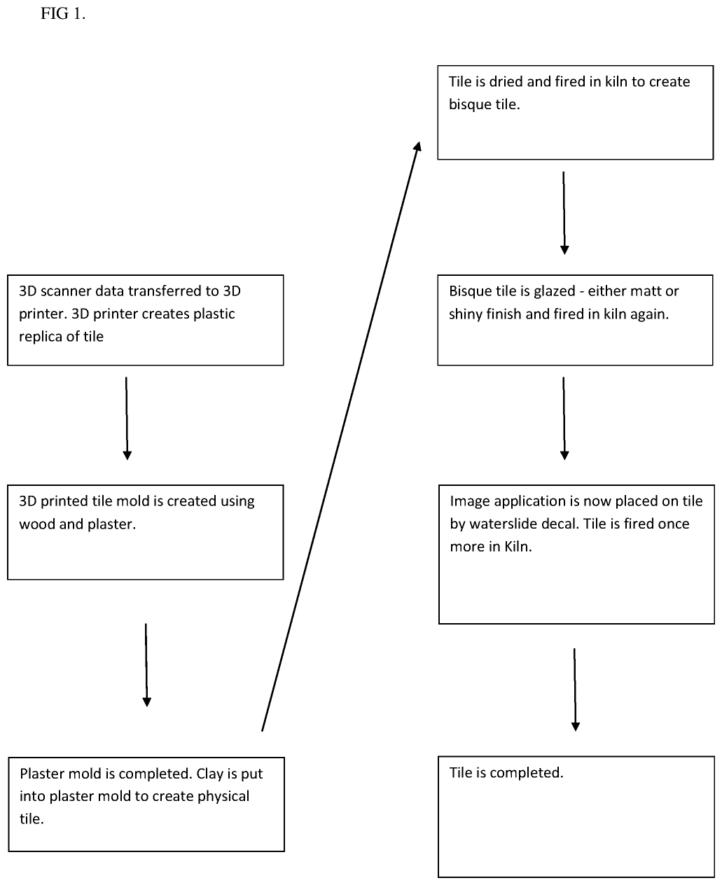

FIG. 1 illustrates a method for 3D scanning and printing according to the present invention.

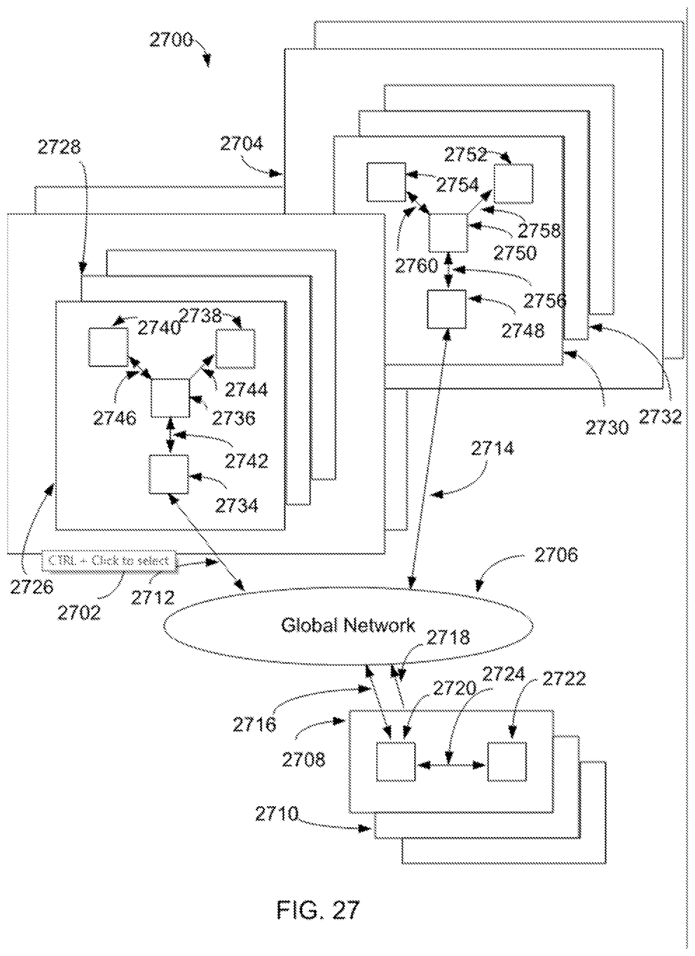

FIG. 27 illustrates a block diagram for an exemplary client/server system which may be used by an exemplary web-enabled/networked embodiment of the present invention.

### DETAILED DESCRIPTION

The current process is shown in FIG. 1. As seen in figure one, the target part, is scanned by conventional two- and three-dimensional scanning techniques with the target part image converted to a computerized model of the target part. This process of scanning and printing may collectively, in combination, and/or alternatively be referred to as 3D scanning, 3D printing, 3D replication, Molding, Casting, and/or Matching and/or Replicating. This process can be used to replication a portion or any building and/or construction, or newly created material to be used in construction and/or building, material including but not limited to tile, roofing, flooring, trim, moldings, mdf, fences, walls, wood, blocks, masonry, metal, siding, doors, beams, brick, vinyl, and/or decorative items, whether man made or not, for the purpose and intent of replicating, recreating, matching, comparing, creating equal, duplicate, alike, identical, similar, resemblant, etc. and/or creation of a new or similar material, of like kind and quality with/and/or similar and/or design, construction, material, shape, color, texture, size, of an already existing and/or being constructed, designed and/or recreated, construction and/or building material.

Preferably, the current process can be used to replicate tiles and ceramics. However, other materials, items, and process can be used in this method to create other materials as explained herein.

When a discontinued flooring tile is broken or chipped, it cannot be replaced because it hasn't been made in many years and suppliers have none of the damaged item in stock. Further, asking a manufactured to remake discontinued item can be prohibitively expensive, especially if made in small quantities.

The disclosed method uses a combination of 3d scanning, 3d printing, custom tile creation and image application to replicate and recreate manufactured discontinued tile flooring. The preferred process for preferably replicating ceramic tiles, as seen in FIG. 1. is as follows:

3D Scan, if possible, an undamaged tile or 3D scan a damaged tile. If no undamaged tile is available, a damaged tile may be scanned. However, the damaged tile may not represent the whole tile. In those cases, a user can utilize computer software to extrapolate the appearance, size and shape of the complete tile. CAD, Slicer, and other similar programs could be used for the modeling of the damaged tile.

The computerized tile may be enlarged a certain percent to account for clay shrinkage or modification. In some instances, this enlargement may be from 0.000001% to over 100000% increase depending on the material used. Once the computerized tile is complete a replication of the damaged tile is 3D printed using common 3D printing filament including but not limited to PLA, ABS, PC, Nylon, CPE/PET, Metal & Metal Like Material, Wood & Wood Like Material, Ceramics & similar, concretes & similar, etc.

Once the replicated tile is made, if multiple tiles are needed, a mold may be made out of wood, plaster, concrete, metal, polymers, or other material as available or needed. The mold is typically bigger than the tile and can be as little as 0.00001 inches bigger to over several feet bigger than the tile. The tile can be coated with a mold release and plaster poured into the mold box. After the mold had dried, the tile is removed, and the mold can be used to create more tiles.

If the 3D printer substrate is ceramic, a mold may be inverted and printed using coming 3D printing filament. The ceramic printer would print directly into the inverted mold.

The tiles are dried and then fired in a kiln. After the tile has been fired, depending on the image application used, we may apply a glaze to the tile and fire again in the kiln. After the tile has been fired twice—once for bisque and once for glazing, the next step in the process is image application. Again, glazing process may be changed pending on image application used and images may be applied prior to first, second, similar, or multiple glazing series.

Alternately, in certain circumstances, the tile is able to be fired only once, combining the bisque & glazing firing into one fire session.

For image application, we take a photographic or similar and/or scanned, and/or 3D scanned image of the tile and modify, edit, distort, adjust, enhance, etc. using a program. The most commonly used program is Photoshop, but any visual or image editing program will work.

The image is adjusted to closely match the image of the original subject—tile in this case—and print using a specialty printer designed/converted to be able to print ceramic inks or inks that can be used on other material if the tile is not made of ceramics. Once the image is printed, it is laminated/coated/protected/covered, etc. with a special film allowing it to be placed in water and slid off—commonly referred to as a water slide decal. This process is done with a machine laminator, but it encompasses coating the product with screen printing, hand covering, placing lamination film on top of the item and heating in any way, etc. Once image is protected, it is placed in liquid, and then placed onto the newly created tile. After the image is placed, the tile is heated/fired once again to “set” the image into the tile.

In some instances, local access to a printer may not be possible. In these cases, the images may be taken by a remote team and transmitted to a printing and imaging facility not on site. These images and data can be transmitted via wireless, wired or cellular connection to the internet and a server to process the images and control the printing of the replacement tiles.

As used throughout this application, a “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128s or 256 bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RANI to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and COREA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

FIG. 27 is a block diagram depicting an exemplary client/server system which may be used by an exemplary web-enabled/networked embodiment of the present invention.

A communication system 2700 includes a multiplicity of clients with a sampling of clients denoted as a client 2702 and a client 2704, a multiplicity of local networks with a sampling of networks denoted as a local network 2706 and a local network 2708, a global network 2710 and a multiplicity of servers with a sampling of servers denoted as a server 2712 and a server 2714.

Client 2702 may communicate bi-directionally with local network 2706 via a communication channel 2716. Client 2704 may communicate bi-directionally with local network 2708 via a communication channel 2718. Local network 2706 may communicate bi-directionally with global network 2710 via a communication channel 2720. Local network 2708 may communicate bi-directionally with global network 2710 via a communication channel 2722. Global network 2710 may communicate bi-directionally with server 2712 and server 2714 via a communication channel 2724. Server 2712 and server 2714 may communicate bi-directionally with each other via communication channel 2724. Furthermore, clients 2702, 2704, local networks 2706, 2708, global network 2710 and servers 2712, 2714 may each communicate bi-directionally with each other.

In one embodiment, global network 2710 may operate as the Internet. It will be understood by those skilled in the art that communication system 2700 may take many different forms. Non-limiting examples of forms for communication system 2700 include local area networks (LANs), wide area networks (WANs), wired telephone networks, wireless networks, or any other network supporting data communication between respective entities.

Clients 2702 and 2704 may take many different forms. Non-limiting examples of clients 2702 and 2704 include personal computers, personal digital assistants (PDAs), cellular phones and smartphones.

Client 2702 includes a CPU 2726, a pointing device 2728, a keyboard 2730, a microphone 2732, a printer 2734, a memory 2736, a mass memory storage 2738, a GUI 2740, a video camera 2742, an input/output interface 2744 and a network interface 2746.

CPU 2726, pointing device 2728, keyboard 2730, microphone 2732, printer 2734, memory 2736, mass memory storage 2738, GUI 2740, video camera 2742, input/output interface 2744 and network interface 2746 may communicate in a unidirectional manner or a bi-directional manner with each other via a communication channel 2748. Communication channel 2748 may be configured as a single communication channel or a multiplicity of communication channels.

CPU 2726 may be comprised of a single processor or multiple processors. CPU 2726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 2736 is used typically to transfer data and instructions to CPU 2726 in a bi-directional manner. Memory 2736, as discussed previously, may include any suitable computer-readable media, intended for data storage, such as those described above excluding any wired or wireless transmissions unless specifically noted. Mass memory storage 2738 may also be coupled bi-directionally to CPU 2726 and provides additional data storage capacity and may include any of the computer-readable media described above. Mass memory storage 2738 may be used to store programs, data and the like and is typically a secondary storage medium such as a hard disk. It will be appreciated that the information retained within mass memory storage 2738, may, in appropriate cases, be incorporated in standard fashion as part of memory 2736 as virtual memory.

CPU 2726 may be coupled to GUI 2740. GUI 2740 enables a user to view the operation of computer operating system and software. CPU 2726 may be coupled to pointing device 2728. Non-limiting examples of pointing device 2728 include computer mouse, trackball and touchpad. Pointing device 2728 enables a user with the capability to maneuver a computer cursor about the viewing area of GUI 2740 and select areas or features in the viewing area of GUI 2740. CPU 2726 may be coupled to keyboard 2730. Keyboard 2730 enables a user with the capability to input alphanumeric textual information to CPU 2726. CPU 2726 may be coupled to microphone 2732. Microphone 2732 enables audio produced by a user to be recorded, processed and communicated by CPU 2726. CPU 2726 may be connected to printer 2734. Printer 2734 enables a user with the capability to print information to a sheet of paper.

CPU 2726 may be connected to video camera 2742. Video camera 2742 enables video produced or captured by user to be recorded, processed and communicated by CPU 2726.

CPU 2726 may also be coupled to input/output interface 2744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 2726 optionally may be coupled to network interface 2746 which enables communication with an external device such as a database or a computer or telecommunications or internet network using an external connection shown generally as communication channel 2716, which may be implemented as a hardwired or wireless communications link using suitable conventional technologies. With such a connection, CPU 2726 might receive information from the network, or might output information to a network in the course of performing the method steps described in the teachings of the present invention.

Additionally, there are other ways the invention could be made. This section describes some of the combinations that result in recreating/replicating/reproducing a ceramic tile. This process can be used for other building materials and is not exclusive to ceramic and/or porcelain tiles.

What is claimed is:

1. The method for a ceramic 3D printing shaping comprising the following steps:
(1) build a two or three dimensional computerized model of target part, wherein the computerized model is a formatted file compatible with a three dimensional printer;
(2) 3D printing a replication of the target part;
(3) Creating mold from replication;
(3) firing the target part to harden; possibly multiple times;
(4) scanning an image of the design on the part in a computerized file;
(5) placing the image of the design onto the part.
